(19) United States
(12) Patent Application Publication
(10) Pub. No.: US 2022/0187929 A1
(43) Pub. Date: Jun. 16, 2022

(54) ELECTRONIC DEVICE, CONTROL METHOD, AND COMPUTER PROGRAM PRODUCT THEREOF

(71) Applicant: ASUSTeK COMPUTER INC., TAIPEI (TW)

(72) Inventors: Shuai-Yi LU, TAIPEI (TW); Chi-Feng YANG, TAIPEI (TW); Bo-Chao JHAN, TAIPEI (TW); Sheng-Yi CHEN, TAIPEI (TW); Je-Yu LIN, TAIPEI (TW); Kuei-Peng CHANG, TAIPEI (TW); Wei-Kang WANG, TAIPEI (TW)

(21) Appl. No.: 17/545,619

(22) Filed: Dec. 8, 2021

(30) Foreign Application Priority Data
Dec. 14, 2020 (TW) 109144007

(51) Int. Cl. G06F 3/038; G06F 9/451; G06F 1/16; G06F 3/0362

(52) U.S. Cl. CPC G06F 3/038; G06F 3/0362; G06F 1/169; G06F 9/451

(57) ABSTRACT

An electronic device is provided. The electronic device includes a knob, a user interface (UI) module, and a human interface device (HID) module. The knob is configured to generate a motion signal. The UI module is configured to generate a setting signal. The HID module includes a first HID definition and a second HID definition stored therein and communicates with the UI module. The HID module interprets the motion signal based on the first HID definition or the second HID definition according to the setting signal to generate input information transferred to the operating system. A control method and a computer program product of the electronic device are also provided.

### CROSS-REFERENCE TO RELATED APPLICATION

This application claims the priority benefit of Taiwan application serial No. 109144007, filed on Dec. 14, 2020. The entirety of the above-mentioned patent application is hereby incorporated by reference herein and made a part of the specification.

### BACKGROUND OF THE INVENTION

### Field of the Invention

The disclosure relates to an electronic device, and in particular, to an electronic device, a control method and a computer program product thereof that support knob input.

### Description of the Related Art

With the development of technologies, users' requirement for human interface device becomes more. Compared with a key switch, a knob switch provides users more diverse operating options.

However, the conventional electronic devices are limited by hardware and software configurations, so that the knob switch is hard to be implemented.

### BRIEF SUMMARY OF THE INVENTION

The disclosure provides an electronic device, and the electronic device includes an operating system (OS). The electronic device includes a knob, a user interface (UI) module, and a human interface device (HID) module. The knob is configured to generate a motion signal. The UI module is configured to generate a setting signal. The HID module stores a first HID definition and a second HID definition, and communicates with the UI module. The HID module interprets the motion signal based on the first HID definition or the second HID definition according to the setting signal to generate input information transferred to the OS.

The disclosure provides a control method applicable to an electronic device. The electronic device includes a knob, and the knob is configured to generate a motion signal. The control method includes: providing a first HID definition and a second HID definition; generating a setting signal through the UI module; and interpreting the motion signal based on the first HID definition or the second HID definition according to the setting signal to generate or perform a corresponding operation.

The disclosure further provides a computer program product encoded on at least one non-transitory computer-readable medium for a computer device, where the computer device includes an OS. The computer program product includes a first program code, a second program code, and a third program code. The first program code describes a first HID definition and a second HID definition. The second program code describes a UI module, and the UI module generates a setting signal. The third program code describes an HID module. The HID module interprets a motion signal based on the first HID definition or the second HID definition according to the setting signal to generate input information transferred to the OS.

Through the electronic device, the control method and it's computer program product provided in the disclosure, the motion signal of the knob is interpreted and controlled based on first HID definition or second HID definition. In this way, a plurality of different usage manners and usage situations is provided by cooperating with a plurality of action modes of the knob, thereby effectively exerting advantages of knob input.

### BRIEF DESCRIPTION OF THE DRAWINGS

FIG. 1 is a schematic block diagram of an embodiment of an electronic device according to the disclosure;

FIG. 1A is a three-dimensional diagram of an embodiment of an electronic device in FIG. 1;

FIG. 2 is a schematic block diagram of an embodiment of a human interface device module in FIG. 1;

FIG. 3 is a flowchart of an embodiment of a control method according to the disclosure; and

FIG. 4 is a schematic block diagram of another embodiment of an electronic device according to the disclosure.

### DETAILED DESCRIPTION OF THE EMBODIMENTS

More detailed descriptions of the specific embodiments of the disclosure are provided below with reference to the accompanying drawings. The features and advantages of the disclosure are described more clearly according to the following description and claims. It should be noted that all of the drawings use very simplified forms and imprecise proportions, only being used for assisting in conveniently and clearly explaining the objective of the embodiments of the disclosure.

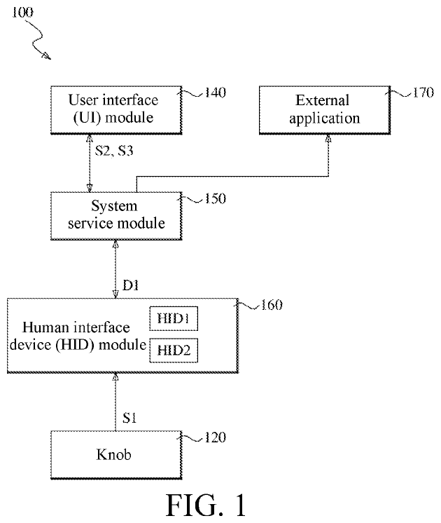

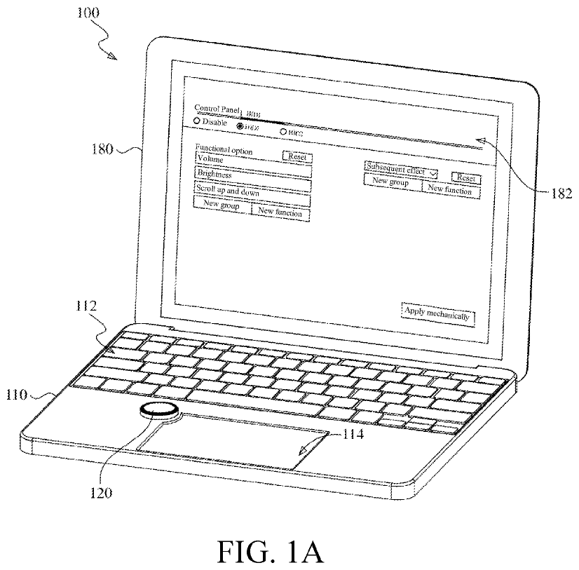

FIG. 1 is a schematic block diagram of an embodiment of an electronic device according to the disclosure. The electronic device 100 is a notebook computer, a desktop computer, or other electronic devices supporting knob input.

As shown in the figure, the electronic device 100 includes a knob 120, a user interface (UI) module 140, and a human interface device (HID) module 160. The knob 120 is configured to generate a motion signal S1. The motion signal S1 is a signal generated by a user operating the knob 120, and includes a pressing signal or a rotating signal. The UI module 140 is configured to generate a setting signal S2. The setting signal S2 is a signal generated by another input device other than the knob 120 through the UI module 140. The setting signal S2 is used for determining a setting manner of the knob 120.

FIG. 1A is a three-dimensional diagram of an embodiment of an electronic device in FIG. 1. In the figure, the notebook computer is used as an example. As shown in the figure, the electronic device 100 includes a host 110 and a screen 180. The knob 120 is integrated on the host 110, and is located between a keyboard 112 and a touchpad 114.

The UI module 140 generates an operation interface 182 corresponding to the knob 120, and the operation interface 182 is displayed on the screen 180. The user directly performs operations on the operation interface 182. In an embodiment, the setting signal S2 is generated by operating the operation interface 182 through a pointing device (in an embodiment, a mouse, a touchpad, or a touch panel). In an embodiment, the UI module 140 is an application installed on an operating system (OS). In an embodiment, the operation interface 182 provides the user to set related parameters for knob operation, such as volume adjustment, brightness adjustment, and scrolling mode, and allows the user to customize functions.

The HID module 160 stores a first HID definition HID1 and a second HID definition HID2. The first HID definition HID1 and the second HID definition HID2 both correspond to the knob 120, and are used for describing an action of the knob 120.

When it is set to interpret the action of the knob 120 according to the first HID definition HID1, the motion signal S1 of the knob 120 is interpreted by the HID module 160 according to the first HID definition HID1. When it is set to interpret the action of the knob 120 according to the second HID definition HID2, the motion signal S1 of the knob 120 is interpreted by the HID module 160 according to the second HID definition HID2.

In an embodiment, the first HID definition HID1 and the second HID definition HID2 are different. The second HID definition HID2 only provides basic functions. Compared with the second HID definition HID2, the first HID definition HID1 further includes a description of additional functions for a user to use.

In an embodiment, the second HID definition HID2 is a preset definition of the OS for the knob 120.

In an embodiment, the HID module 160 is a firmware. In an embodiment, the first HID definition HID1 and the second HID definition HID2 are pre-stored in a read-only memory (ROM) by a product provider.

In an embodiment, either of the first HID definition HID1 or the second HID definition HID2 is set to be modified by the user. However, a functional option derived from the first HID definition HID1 is set to be adjusted according to actual requirements of a user. In an embodiment, the knob 120 is operated to adjust the volume and brightness, disable or enable an up and down scrolling function by the user.

The HID module 160 communicates with the UI module 140, and interprets the motion signal S1 of the knob 120 based on the first HID definition HID1 or interprets the motion signal S1 of the knob 120 based on the second HID definition HID2 according to the setting signal S2 generated by the UI module 140, to generate input information D1, and output the input information D1 to the OS.

In the above embodiment where the HID module 160 interprets the motion signal S1 of the knob 120 based on the first HID definition HID1 or interprets the motion signal S1 of the knob 120 based on the second HID definition HID2 according to the setting signal S2, the UI module 140 is alternatively configured to generate an operation signal S3 corresponding to the pressing and rotating actions of the knob 120, in addition to generating the setting signal S2 dedicated to setting the knob 120.

In an embodiment, the HID module 160 interprets an action of the knob 120 based on the first HID definition HID1 or interprets an action of the knob 120 based on the second HID definition HID2 according to the operation signal S3. In an embodiment, when the operation signal S3 is set to interpret the action of the knob 120 according to the second HID definition HID2, when the motion signal S1 is received from the knob 120, interpretation is performed according to the second HID definition HID2.

In an embodiment, a system service module 150 is further included between the UI module 140 and the HID module 160. The system service module 150 is used as a communication bridge between the UI module 140 and the HID module 160. In an embodiment, the system service module 150 is a service program installed on the OS.

In an embodiment, when the HID module 160 interprets the motion signal S1 of the knob 120 based on the first HID definition HID1 according to the setting signal S2 to generate the input information D1, the system service module 150 intervenes in operation and performs a necessary operation according to the input information D1.

In an embodiment, when the motion signal S1 needs to be executed, based on the first HID definition HID1, with other external applications, the system service module 150 enables a corresponding external application 170 to expand the usage modes and usage situations of the knob 120. The external application 170 is a graphics program, a game program, or the like installed on the OS.

On the contrary, when the HID module 160 interprets the action of the knob 120 based on the second HID definition HID2 according to the setting signal S2, the system service module 150 does not intervene, and a preset service program in the OS is used for controlling and operating.

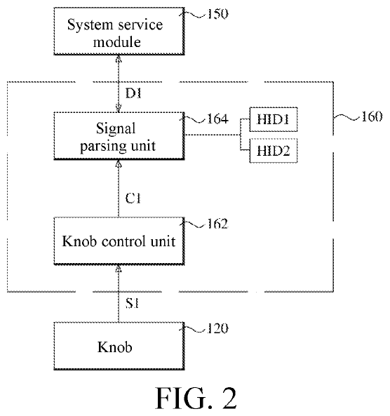

FIG. 2 is a schematic block diagram of an embodiment of an HID module 160 in FIG. 1. As shown in the figure, the HID module 160 includes a knob control unit 162 and a signal parsing unit 164. The knob control unit 162 is electrically connected to the knob 120, and is configured to parse the motion signal S1 of the knob 120 to generate motion information C1. The signal parsing unit 164 interprets, based on the first HID definition HID1 or the second HID definition HID2, the motion information C1, to generate the input information D1.

In an embodiment, the signal parsing unit 164 interprets the motion information C1 based on the first HID definition HID1 or the second HID definition HID2 according to a setting of the setting signal S2 or the operation signal S3 to generate the input information D1.

In addition, the signal parsing unit 164 further communicates with the system service module 150, and the system service module 150 performs a corresponding operation according to the input information D1, and in an embodiment, the system service module 150 changes the operation interface 182, generates a control instruction, or enables the corresponding external application according to the input information D1.

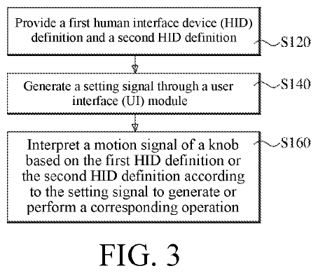

FIG. 3 is a flowchart of an embodiment of a control method according to the disclosure. The control method configures for the electronic device 100 shown in FIG. 1.

First, as described in step 5120, provide the first HID definition HID1 and the second HID definition HID2. In an embodiment, in this step, the first HID definition HID1 and the second HID definition HID2 are stored in a ROM.

In an embodiment, the first HID definition HID1 and the second HID definition HID2 are different. The second HID definition HID2 provides basic functions. The first HID definition HID1 provides additional functions for a user.

Next, as described in step 5140, generate the setting signal S2 through the UI module 140. In an embodiment, the setting signal S2 is generated by clicking the operation interface 182 through a pointing device, such as a mouse, a touchpad, or a touch panel. In an embodiment, the UI module 140 is an application installed on the OS.

Next, as described in step 5160: interpret the motion signal 51 of the knob 120 based on the first HID definition HID1 or the second HID definition HID2 according to the setting signal S2 to generate or perform the corresponding operation. In an embodiment, this step is performed by the HID module 160 in FIG. 1 with the OS.

The disclosure also provides a computer program product encoded on at least one non-transitory computer-readable medium for a computer device, to implement the control method shown in FIG. 3 in a manner of software or a combination of hardware and software. The computer program product is disposed on any known computer-readable medium such as a tape, a semiconductor, a floppy disk, an optical disc (such as a CD-ROM and a DVD-ROM), a network connection, wireless or another communication media.

Specifically, the computer program product includes a first program code, a second program code, and a third program code. The first program code describes the first HID definition and the second HID definition. The second program code describes a UI module, and the UI module generates a setting signal. The third program code describes an HID module. The HID module interprets a motion signal based on the first HID definition or the second HID definition according to the setting signal to generate input information transferred to the OS.

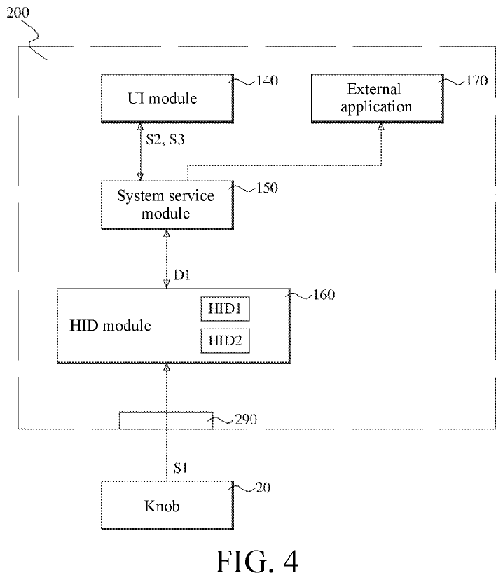

FIG. 4 is a schematic block diagram of another embodiment of an electronic device according to the disclosure. The electronic device 200 is a notebook computer, a desktop computer, or other electronic devices supporting knob input.

As shown in the FIG. 4, the electronic device 200 of the disclosure is connected to an external knob 20 through a connector 290. The motion signal 51 generated by the knob 20 is transmitted to the HID module 160 in the electronic device 200 through the connector 290.

In an embodiment, the connector 290 is a universal serial bus (USB) connector. Other elements of this embodiment are similar to the embodiment in FIG. 1. Details are not described herein.

Based on the above, through the electronic device 100, the control method and it's computer program product provided in the disclosure, the motion signal S1 of the knob 120 is interpreted and controlled according to the first HID definition HID1 or the second HID definition HID2. In this way, a plurality of different usage manners and usage situations is provided by cooperating with a plurality of action modes of the knob 120, thereby effectively exerting advantages of knob 120 input.

The above is merely preferred embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. An electronic device, comprising an operating system (OS), the electronic device comprising:
a knob, configured to generate a motion signal;
a user interface (UI) module, configured to generate a setting signal; and
a human interface device (HID) module, comprising a first HID definition and a second HID definition stored therein, and communicating with the UI module, wherein the HID module interprets the motion signal based on the first HID definition or the second HID definition according to the setting signal to generate input information transferred to the OS.

2. The electronic device according to claim 1, further comprising a screen, wherein the UI module generates an operation interface corresponding to the knob, and the operation interface is displayed on the screen.

3. The electronic device according to claim 1, wherein the HID module is a firmware.

4. The electronic device according to claim 1, wherein the first HID definition is different from the second HID definition, and the second HID definition is a preset definition of the OS.

5. The electronic device according to claim 4, further comprising a system service module, wherein when the HID module interprets the motion signal based on the first HID definition according to the setting signal to generate the input information, the system service module selectively enables at least one corresponding external application according to the input information.

6. The electronic device according to claim 1, wherein the HID module comprises a knob control unit and a signal parsing unit, the knob control unit is configured to parse the motion signal to generate motion information, the signal parsing unit interprets the motion information based on the first HID definition or the second HID definition according to the setting signal to generate the input information.

7. A control method, applicable to an electronic device, wherein the electronic device comprises a knob, the knob is configured to generate a motion signal, and the control method comprises:
providing a first human interface device (HID) definition and a second HID definition;
generating a setting signal through a user interface (UI) module; and
interpreting the motion signal based on the first HID definition or the second HID definition according to the setting signal to generate or perform a corresponding operation.

8. The control method according to claim 7, wherein a step of providing the first HID definition and the second HID definition comprises storing the first HID definition and the second HID definition by using a read-only memory (ROM).

9. The control method according to claim 8, further comprising selectively enabling at least one corresponding external application according to the motion signal when the HID module interprets the motion signal based on the first HID definition according to the setting signal.

10. A computer program product encoded on at least one non-transitory computer-readable medium for a computer device, wherein the computer device comprises an operating system (OS), and the computer program product comprising:
a first program code, describing a first human interface device (HID) definition and a second HID definition;
a second program code, describing a user interface (UI) module, wherein the UI module generates a setting signal; and
a third program code, describing an HID module, wherein the HID module interprets a motion signal based on the first HID definition or the second HID definition according to the setting signal to generate input information transferred to the OS.
